(19) United States
(12) Patent Application Publication
(10) Pub. No.: US 2026/0214439 A1
(43) Pub. Date: Jul. 23, 2026

(54) APPARATUS, COMPUTER PROGRAM, AND METHODS FOR ENCRYPTION/DECRYPTION

(71) Applicant: Sony Group Corporation, Tokyo (JP)

(72) Inventors: Tri Khac VU, Stuttgart (DE); Olivier ELSHOCHT, Stuttgart (DE); Francis MEYVIS, Stuttgart (DE); Dimitri TORFS, Stuttgart (DE)

(73) Assignee: Sony Group Corporation, Tokyo (JP)

(21) Appl. No.: 19/138,689

(22) PCT Filed: Jan. 2, 2024
(86) PCT No.: PCT/EP2024/050020

§ 371 Date: Jun. 13, 2025

(30) Foreign Application Priority Data
Jan. 13, 2023 (EP) 23151590.9

(51) Int. Cl. H04W 12/037

(52) U.S. Cl. CPC H04W 12/037

(57) ABSTRACT

Embodiments of the present disclosure relate to an apparatus, a computer program, and methods for encryption/decryption. The method for a transmitter and for encrypting a message comprises obtaining information on a position of the transmitter, obtaining a time of the message, and encrypting the message using symmetric encryption based on the information on the position and the time of the message.

### FIELD

Embodiments of the present disclosure relate to an apparatus, a computer program, and methods for encryption/decryption. In particular, but not exclusively, the present disclosure relates to an encryption/decryption concept for symmetric encryption/decryption of messages com-plying with a Low Power Wide Area (LPWA) wireless communication standard.

### BACKGROUND

Telecommunications play an increasingly important role in various fields of science and technology. In practice, ensuring an authenticity, integrity, confidentiality, and/or the freshness of messages is of particular importance in telecommunications applications. However, conventional approaches for this may require a significant portion of the message.

Hence, there is a demand of an improved solution for this.

### SUMMARY

This demand is met by the subject-matter of the appended independent claims. Advantageous embodiments are addressed by the dependent claims.

Embodiments of the present disclosure provide a method for a transmitter and for encrypting a message, the method comprising obtaining information on a position of the transmitter, obtaining a time of the message, and encrypting the message using symmetric encryption based on the information on the position and the time of the message. This, e.g., allows a receiver to decrypt the encrypted message using an expected position and an expected time of the message for authentication of the encrypted message. So, the method allows the receiver to check the authenticity of the message through the decryption of the encrypted message. In this way, the encryption of the message serves not only to maintain secrecy, but also as proof of the position and time for authentication. In other word, the proof of the position and the time is integrated in the encryption of the message. In this way, the authentication requires a smaller portion of the message than in other approaches. In applications with a small/limited message length (e.g., in connection with ELTRES™, see below) which is not sufficient for extra information for authentication, this may allow an authentication of the message.

In various examples, encrypting the message comprises generating a nonce based on the time and the information on the position, and encrypting the message using the nonce. This provides a unique and/or varying encryption and, so, allows to ward off replay attacks.

According to an example, obtaining information on the position may comprise determining an actual position of the transmitter using a positioning system, and the information on the position may be indicative of the expected position if the actual position deviates from the expected position by no more than a predetermined maximum distance. In this way, the message may be authenticated by the actual position of the transmitter and technically related or other usual and/or uncritical deviations from the expected position are allowed.

In some embodiments, the time of the message may be indicative of a time of encryption of the message.

In some examples, the time may be indicative of a time slot of the message for the receiver to determine the time slot from a time of receipt to obtain the expected time. This, in practice, makes it technically easier for the receiver to determine the time for encryption than for a certain or exact point in time.

The method further may comprise obtaining an identifier of the message and encrypting the message further may comprise encrypting the message using the identifier. In this way, e.g., messages of the same receiver which are associated with the same time can be distinguished. So, this allows the receiver to distinguish between such messages by the identifier.

Further, the method may comprise transmitting the encrypted message to the receiver.

A skilled person having benefit from the present disclosure will appreciate that the proposed method, e.g., may be applied for communication with stationary sensors or other stationary transmitters. Accordingly, the message may be indicative of sensor data of a stationary sensor or any other stationary transmitter.

As well, the skilled person will appreciate that the proposed method is particularly advantageous in applications where a capacity or length of the message is limited and/or relatively small. In such applications, the length or capacity is standardized and, thus, predefined. In practice, the message, e.g., complies with a Low Power Wide Area (LPWA) wireless communication standard.

The proposed method, e.g., is applied in communications application and in connection with a respective method for a receiver of the encrypted message.

Accordingly, embodiments of the present disclosure may relate to a method for a receiver and for decrypting an encrypted message, the method comprising receiving the encrypted message, wherein the message is encrypted using symmetric encryption based on information on a position of a transmitter of the message and a time of the message for the receiver to decrypt the encrypted message using an expected position and an expected time of the message for authentication of the encrypted message, obtaining the expected position of the transmitter of the encrypted message, obtaining the expected time of the message, and decrypting the encrypted message using the expected position and the expected time.

In some examples, decrypting the encrypted message comprises generating a nonce based on the expected position and the expected time, and decrypting the encrypted message based on the nonce.

According to an example, obtaining the expected time for decrypting the message comprises obtaining a reception time of the encrypted message, and determining the expected time of the message from the reception time.

In some examples, the expected position may be hardcoded in the receiver or obtained from an external database server.

An aspect of the present disclosure relates to a computer program having a program code for performing a method according to the present disclosure when the program may be executed on a processor or a programmable hardware.

Some aspects of the present disclosure relate to an apparatus for encryption/decryption, the apparatus comprising one or more interfaces for communication, and a processing circuit configured to control the one or more interfaces and to carry out a method of the present disclosure using the one or more interfaces.

### BRIEF DESCRIPTION OF THE FIGURES

Some examples of apparatuses and/or methods will be described in the following by way of example only, and with reference to the accompanying figures, in which

FIG. 1 shows a flow chart schematically illustrating an embodiment of a method for a transmitter and for encrypting a message;

FIG. 2 shows a flow chart schematically illustrating an embodiment of a method for a receiver and for decrypting an encrypted message;

FIG. 3 schematically illustrates an exemplary use case of the proposed approach;

FIG. 4 shows a block diagram schematically illustrating an embodiment of an encryption and decryption procedure according to the proposed approach; and

FIG. 5 shows a map to illustrate positional information for encryption/decryption.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

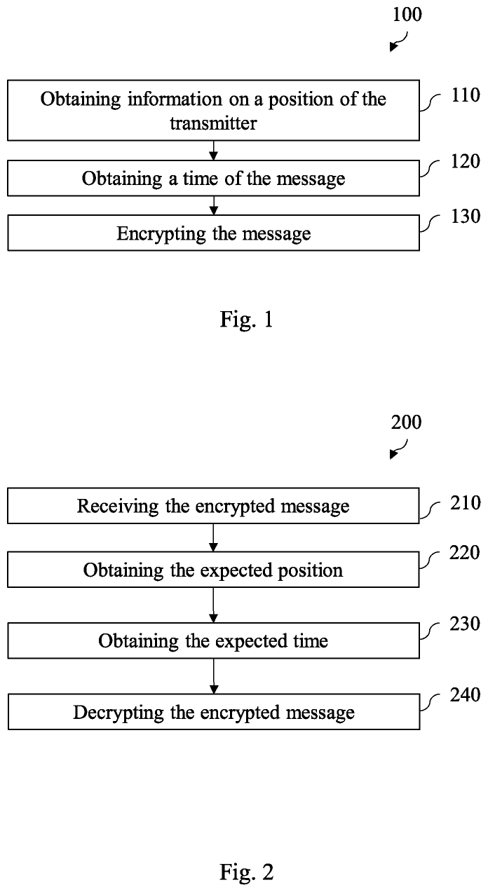

FIG. 1 shows a flow chart schematically illustrating an embodiment of a method 100 for a transmitter and for encrypting a message. In context of the present disclosure, the transmitter may be any device for sending information via electromagnetic signals. In practice, the transmitter may be configured for wireless or wired transmission of the message via electromagnetic signals. Accordingly, the message can be any type of electromagnetic communication of information. In embodiments, the message, e.g., includes measurement data, image data, or any other type of data.

The method 100 comprises obtaining 110 information on a position of the transmitter. Such information can be any information indicating where the transmitter is placed. In various embodiments, the information on the position, e.g., includes geographical coordinates of the transmitter. In practice, the information on the position, e.g., is obtained from a positioning system. In exemplary embodiments, various positioning systems may be used for this. In practice, e.g., the positioning system may use different technologies (e.g., time of flight, spatial scan, inertial sensing, mechanical linkage, phase difference, direct field sensing, optical systems, and/or the like) and may comprise or correspond to different types of positioning systems. In practice, the positioning system can be a satellite-based positioning system (e.g., a global positioning system, GPS), a land-based positioning system (e.g., a local positioning system, LPS), and/or an indoor positioning system.

Further, method 100 comprises obtaining 120 a time of the message. In context of the present disclosure, the time of the message can be any information which indicates a freshness of the message. The time of the message, e.g., corresponds to a point in time when the message was created/generated and/or encrypted (e.g., just before the message was encrypted or the encryption was initiated). The time, e.g., is the clock time. Accordingly, the time may be obtained from a clock. In some embodiments, the time can be any other time information indicating how old the message is. In practice, this can be also any time information other than the clock time.

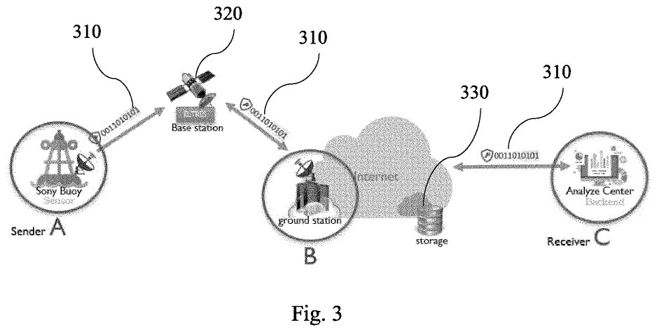

Method 100 further comprises encrypting 130 the message using symmetric encryption based on the information on the position and the time of the message. The encryption, thus, is indicative of the position of the transmitter and of the freshness of the message. To this end, e.g., a cryptographic key or a nonce for encrypting the message is generated based on the information on the position and the time of the message. According to principles of symmetric encryption/decryption, the encrypted message, then, can be decrypted using the same cryptographic key indicative of the information on the position and the time of the message. This enables a receiver to decrypt the encrypted message using the same information on the position and the same time of the message. One finding is that this mechanism can be used to determine whether the message is “young” enough and whether the transmitter is where it is supposed to be. As explained in more detail below with reference to FIG. 2, for this. an inter-related method providing that an expected position of the transmitter and an expected time of the message are applied for decryption may be used to check whether the transmitter is where it is supposed to be and the message is up to date.

FIG. 2 shows a flow chart schematically illustrating an embodiment of a method 200 for a receiver and for decrypting an encrypted message, e.g., the message encrypted by method 100. In context of the present disclosure, the receiver may be any device for receiving information via electromagnetic signals. In practice, the receiver may be configured for wireless or wired reception of the message via electromagnetic signals.

As can be seen from the flow chart, method 200 comprises receiving the encrypted message which is encrypted using symmetric encryption based on information on a position of a transmitter of the message and a time of the message for the receiver to decrypt the encrypted message using an expected position and an expected time of the message for authentication of the encrypted message.

Accordingly, method 200 further comprises obtaining 220 the expected position of the transmitter of the encrypted message, obtaining 230 the expected time of the message, and decrypting 230 the encrypted message using the expected position and the expected time.

As mentioned above, the symmetric encryption provides that the same cryptographic key may be used for both encryption and decryption of the message. Accordingly, the decryption is (only) successful if the expected position and the expected time of the message correspond to the information on the position and the time of the message that have been used for encryption. The expected position and the expected time, e.g., refer to a position where the transmitter is supposed to be and a time when the message was supposed to be sent and/or encrypted. Accordingly, the decryption is (only) successful if an actual position and an actual time of the message which have been determined by the transmitter match the expected position and time. So, the decryption is only successful if the transmitter is where it is supposed to be and if the message was sent when it was supposed to be sent. As the skilled person will appreciate, in this way, the decryption does not only serve to provide a content of the message (in plaintext) but also to authenticate the message. In practice, the decryption, e.g., proves that the transmitter is still where it should be and was not moved away (e.g., as in the case that the transmitter has been stolen or otherwise removed) and that the transmission of the encrypted message was not delayed (as, e.g., in the case that the message has been intercepted and forwarded). In this way, it may be ensured that the transmitter and the message were not manipulated. Also, such manipulations may be detected in the case that the decryption fails.

So, the proposed the encryption/decryption of the message does not only provide secure communication but also removes the requirement for additional portions in the message for an authentication of the message in addition to any payload in the message. Accordingly, the proposed approach allows a more efficient communication, in particular, smaller message formats and/or a more efficient use of a message length.

In exemplary implementations of the proposed approach, the expected position may be communicated before the message is communicated, e.g., when the transmitter was installed at a desired position. The expected time of the message, e.g., may be derived from a reception time of the encrypted message.

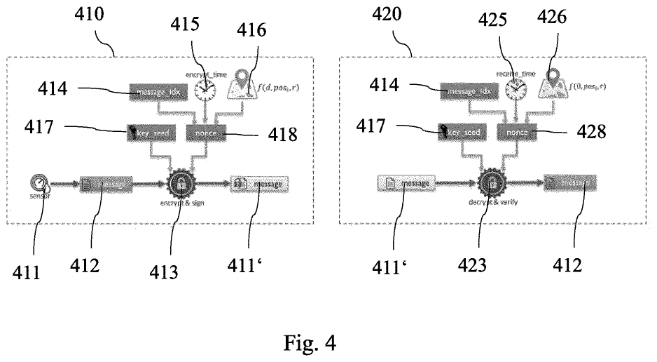

As the skilled person having benefit from the present disclosure will appreciate, the proposed approach may be applied in various use cases. Further aspects and features of embodiments of the proposed approach are described in more detail below with reference to an exemplary use case illustrated by FIG. 3.

As can be seen from FIG. 3, an exemplary use case, e.g., relates to an application for disaster sensing. Disaster sensing, e.g., enables (quick) responses to emergency situations and/or natural catastrophes (e.g., forest fire, earthquake, and/or the like). In the present use case, the application of the proposed approach is used for tsunami warning, i.e., for warning of tsunamis when they occur. As can be seen from FIG. 3, for this, a sender A (transmitter) is installed in a buoy which is equipped with a sensor configured to detect water movements to recognize tsunamis. The exemplary use case provides that sender A obtains information on the water movements from the sensor and transmits an encrypted message 310 including this information to a receiver C. For this, e.g., Low Power Wide Area (LPWA) may be used for a reduced energy consumption and a reduced maintenance demand of the transmitter compared with other communications technologies. As indicated in FIG. 3, e.g., ELTRES M, a system for satellite based LPWA communication is applied. So, sender A transmits the encrypted message 310 to a satellite system 320 which forwards the encrypted message 310 to a ground station B where the encrypted message 310 is (made) available for receiver C. To this end, the encrypted message 310 is stored on a storage 330 where the encrypted message 310 may be retrieved by receiver C, e.g., vie the internet. For this, the ground station may inform receiver C that the encrypted message 310 is available. Then, the receiver C can retrieve and decrypt the encrypted message 310, e.g., to analyze a content of the message, here information on the water movements to detect tsunamis. To this end, receiver C may comprise or at least may be communicatively connected to an analyze center which is able to evaluate the information on the water movements. In practice, messages can be transmitted repeatedly in this way to provide an early detection of a tsunami and take safety measurements before a tsunami reaches land.

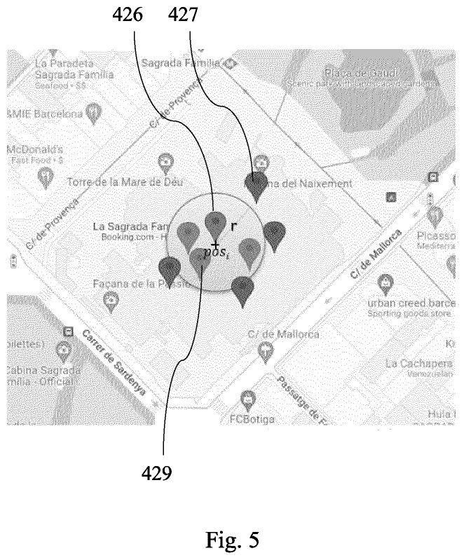

In the illustrated use case, various embodiments of the present approach may be implemented for encrypting and decrypting the message of which an exemplary embodiment is described in more detail below with reference to FIG. 4.

FIG. 4 shows a shows a block diagram schematically illustrating an embodiment of an encryption and decryption procedure according to the proposed approach. More specifically, FIG. 4 shows a first box 410 schematically illustrating an encryption of a message by the transmitter and a second box 420 schematically illustrating a respective decryption by a receiver.

As can be seen in box 410, the transmitter may obtain sensor data from a sensor 411. As mentioned above, the sensor can be configured to detect water movements. However, in general, the sensor can be or comprise any other sensor as well. The sensor data, then is included in a message 412. For this, the sensor data may be processed and incorporated in a predefined message format. In the above use case, the message 412, e.g., complies with an LPWA communication standard, e.g., the ELTRES™ standard.

Then, the message 412 is encrypted using symmetric encryption to generate an encrypted message 411′. For this, a symmetric key algorithm 413 is used with a key seed 417 and a nonce 418 as input for the encryption. The key seed 417 may be a secret key which is known by the transmitter and the receiver. In practice, the transmitter and the receiver are provided with the key seed 417 in a pre-configuration or a handshake process to establish a symmetric key for encrypting and decrypting, respectively, the message 412. The nonce 418 is generated based on an identifier 414 of message 412, a time 415 of message 412, and information 416 on a position of the transmitter. For this, a nonce generation algorithm is applied with the identifier 414, the time 415, and the positional information 416 as input to the nonce generation algorithm.

The time 415 of message 412, here, e.g., is indicative of a time when message 412 is encrypted. So, the time 415 may be a current time. In practice, the time 415, e.g., is a time slot in which message 412 is encrypted. So, the time 415 may be not representative of an exact point in time but a predefined time window to make it easier for a receiver to derive the time 415 from a reception time. The time slot, e.g., is indicated by a clock time or a number of hours, minutes, or second from a predefined point in time. In the present example, the time slot, e.g., is specified by a number of minutes from 1^{st} Jan. 1970 until the moment when the message is encrypted.

The identifier 414, e.g., is an index that is equal to a number of messages that have been encrypted within the same predefined time slot as message 412, before the encryption of message 412, such that the receiver can distinguish between several messages encrypted in the same time slot. Otherwise, any other information that us suitable to distinguish message 412 from other messages may be used as identifier.

The information 416 on the position can be any data indicating an actual and/or current position of the transmitter. In the present example, the information 416 on the position includes geographical coordinates of the transmitter. The geographical coordinates, e.g., are obtained from a positioning system, such as a satellite-based positioning system (GPS).

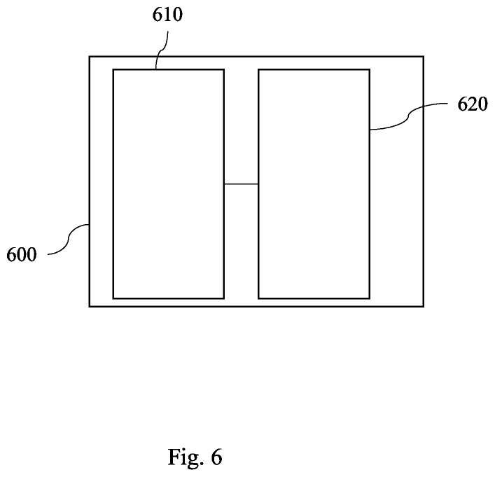

As further illustrated in FIG. 5, in the present example, the information 416 on the position is a function f of an expected position pos of the transmitter, a (absolute) distance d of the actual position of the transmitter from the expected position, and a predetermined maximum distance r of the actual position from the expected position. As illustrated on the map in FIG. 5, function ƒ(d, pos, r), is equal to the expected position pos if the distance d of the actual position is not greater than the maximum distance r. In the example of FIG. 5, ƒ corresponds to the expected position pos if the actual position corresponds to any position, e.g., position 429, within a range/radius equal to r from the expected position pos. So, in this case, the information 416 on the position is indicative of the expected position if the actual position deviates from the expected position by no more than the predetermined maximum distance.

Otherwise, if the actual position is not within said range, e.g., such as position 427, the position is considered unequal to the expected position. Then, e.g., the information 416 on the position is indicative of the actual position unequal to the expected position.

Accordingly, message 412 is only encrypted based on the expected position if the actual position is within the predetermined maximum distance.

Turning to FIG. 4, it can be seen that the encrypted message 411′, then, is communicated to the receiver. There, the receiver applies a symmetric decryption algorithm 423 compatible with the symmetric encryption at the transmitter to the encrypted message 411′with the key seed 417 and a nonce 428. As mentioned above, the key seed 417, e.g., is provided to the receiver beforehand. The nonce 428 is generated using the same nonce generation algorithm and based on the identifier 414 as well as on a receive time or time of receipt 425 and the expected position (numbered “426”).

For this, the expected position can be retrieved from an external database separate from the receiver storing the expected position or can be stored on the receiver when configuring the receiver. In practice, the expected position, e.g., is hardcoded in the receiver.

As mentioned above, the identifier 414, e.g., is indicative of the index. In practice, the receiver may receive each message of the transmitter and, thus, can derive the index by counting the received messages of the same time slot.

In practice, embodiments may provide for multiple successive time slots with a constant pre-defined length. Accordingly, the receiver may derive the correct time (slot) 415 of the encryption for decrypting the encrypted message in consideration of the predetermined length. In the present example, the length of the time slots, e.g., is ten minutes. The receiver may, then, derive the time slot 415 of the encryption by iteration through the last ten minutes from the time of receipt, i.e., through applying symmetric keys for several or each of the last ten minutes. In the implementation of FIG. 3, the time of receipt, e.g., corresponds to a time when the (intermediate) ground station receives message 310 and may be stored by the ground station for the receiver C to estimate the time of encryption from the time of receipt reliably even if receiver C retrieves message 310 significantly later.

Using the same or equivalent nonce generation algorithm as for generating nonce 418, nonce 428 corresponds to nonce 418 if the identifier 414, the time of message 412, and the expected position 426 obtained by the receiver correspond to the identifier 414, the time 415, and the information 416 on the position used for the encryption of message 412. Accordingly, in practice, the decryption may be only successful if said parameters for the generation of nonce 428 are the same as for the generation of nonce 418. Consequently, the decryption is successful if the transmitter is within the predetermined maximum distance from the expected position and if the message is “young” enough, i.e., if the message has been received in the predefined time, here within ten minutes after encrypting message 412. Otherwise, the decryption fails. So, the decryption not only serves for a secure communication but also for an authentication or verification that the transmitter is at or at least close enough to a desired position, a so-called “proof-of-location”, and that the message is not too old, a so-called “proof-of-time”. For even greater safety, the proposed approach may be also applied in connection with a so-called “proof-of-sensor” which provides an identification of the sensor.

Even though, the proposed approach is only illustrated in connection with on-way communication, the skilled person having benefit from the present disclosure will appreciate that the proposed approach may be not only implemented in connection with unidirectional communication but also in connection with bidirectional or multidirectional communication.

As well, the skilled person will appreciate that the proposed approach can be implemented in various use cases other than disaster sensing. Also, the proposed approach may be applied in connection with various communication technologies.

It is also noted that the proposed approach is applicable with various sensors, in particular, with any kind of stationary sensors, but also with mobile sensors.

The present approach can be also implemented in an apparatus, as explained in more detail below with reference to FIG. 6.

FIG. 6 shows a block diagram schematically illustrating an apparatus 600 comprising one or more interfaces 610 and a processing circuit 620 configured to control the one or more interfaces and to carry out a method of the present disclosure using the one or more interfaces 610.

Examples of the interfaces 610 comprise wired or wireless interfaces. In general, the interfaces can comprise any means for communicating (and optionally processing) signals, here, e.g., for examples for the purpose of communicating data for generating the pattern.

The processing circuit can be any data processing circuit for executing any one of the proposed methods. In embodiments, the processing circuit can comprise any programmable hardware (microcontroller, field-programmable-gate array, FPGA, central processing unit, CPU, graphics processing unit, GPU, or the like).

As the skilled person will understand, features and aspects of the proposed methods may also apply to the proposed apparatus. Accordingly, features and aspects of the methods may be also implemented, mutatis mutandis, in the proposed apparatus.

Further embodiments pertain to:
(1) A method for a transmitter and for encrypting a message, the method comprising:
   obtaining information on a position of the transmitter;
   obtaining a time of the message; and
   encrypting the message using symmetric encryption based on the information on the position and the time of the message.
(2) The method of (1), wherein encrypting the message comprises:
   generating a nonce based on the time and the information on the position; and
   encrypting the message using the nonce.
(3) The method of (1) or (2), wherein obtaining information on the position comprises determining an actual position of the transmitter using a positioning system, and wherein the information on the position is indicative of the expected position if the actual position deviates from the expected position by no more than a predetermined maximum distance.
(4) The method of any one of (1) to (3), wherein the time of the message is indicative of a time of encryption of the message.
(5) The method of any one of (1) to (4), wherein the time is indicative of a time slot of the message for the receiver to determine the time slot from a time of receipt to obtain the expected time.
(6) The method of any one of (1) to (5), wherein the method further comprises obtaining an identifier of the message, and wherein encrypting the message further comprises encrypting the message using the identifier.
(7) The method of any one of (1) to (6), wherein the method further comprises transmitting the encrypted message to a receiver.
(8) The method of any one of (1) to (7), wherein the message is indicative of sensor data of a stationary sensor.
(9) The method of any one of (1) to (8), wherein the message complies with a Low Power Wide Area, LPWA, wireless communication standard.
(10) A method for a receiver and for decrypting an encrypted message, the method comprising:
   receiving the encrypted message, wherein the message is encrypted using symmetric encryption based on information on a position of a transmitter of the message and a time of the message for the receiver to decrypt the encrypted message using an expected position and an expected time of the message for authentication of the encrypted message;
   obtaining the expected position of the transmitter of the encrypted message;
   obtaining the expected time of the message; and
   decrypting the encrypted message using the expected position and the expected time.
(11) The method of (10), wherein decrypting the encrypted message comprises:
   generating a nonce based on the expected position and the expected time; and
   decrypting the encrypted message based on the nonce.
(12) The method of (10) or (11), wherein obtaining the expected time for decrypting the message comprises:
   obtaining a reception time of the encrypted message; and
   determining the expected time of the message from the reception time.
(13) The method of any one of (10) to (12), wherein the expected position is hardcoded in the receiver or obtained from an external database server.
(14) A computer program having a program code for performing a method according to any one of (1) to (13) when the program is executed on a processor or a programmable hardware.
(15) An apparatus for encryption/decryption, the apparatus comprising:
   one or more interfaces for communication; and
   a processing circuit configured to control the one or more interfaces and to carry out a method of any one of (1) to (13) using the one or more interfaces.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions,-processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A method for a transmitter and for encrypting a message, the method comprising:
obtaining information on a position of the transmitter;
obtaining a time of the message; and
encrypting the message using symmetric encryption based on the information on the position and the time of the message.

2. The method of claim 1, wherein encrypting the message comprises:
generating a nonce based on the time and the information on the position; and
encrypting the message using the nonce.

3. The method of claim 1, wherein obtaining information on the position comprises determining an actual position of the transmitter using a positioning system, and wherein the information on the position is indicative of the expected position if the actual position deviates from the expected position by no more than a predetermined maximum distance.

4. The method of claim 1, wherein the time of the message is indicative of a time of encryption of the message.

5. The method of claim 1, wherein the time is indicative of a time slot of the message for the receiver to determine the time slot from a time of receipt to obtain the expected time.

6. The method of claim 1, wherein the method further comprises obtaining an identifier of the message, and wherein encrypting the message further comprises encrypting the message using the identifier.

7. The method of claim 1, wherein the method further comprises transmitting the encrypted message to a receiver.

8. The method of claim 1, wherein the message is indicative of sensor data of a stationary sensor.

9. The method of claim 1, wherein the message complies with a Low Power Wide Area, LPWA, wireless communication standard.

10. A method for a receiver and for decrypting an encrypted message, the method comprising:
receiving the encrypted message, wherein the message is encrypted using symmetric encryption based on information on a position of a transmitter of the message and a time of the message for the receiver to decrypt the encrypted message using an expected position and an expected time of the message for authentication of the encrypted message;
obtaining the expected position of the transmitter of the encrypted message;
obtaining the expected time of the message; and
decrypting the encrypted message using the expected position and the expected time.

11. The method of claim 10, wherein decrypting the encrypted message comprises:
generating a nonce based on the expected position and the expected time; and
decrypting the encrypted message based on the nonce.

12. The method of claim 10, wherein obtaining the expected time for decrypting the message comprises:
obtaining a reception time of the encrypted message; and
determining the expected time of the message from the reception time.

13. The method of any claim 10, wherein the expected position is hardcoded in the receiver or obtained from an external database server.

14. A computer program having a program code for performing a method according to claim 1 when the program is executed on a processor or a programmable hardware.

15. An apparatus for encryption/decryption, the apparatus comprising:
one or more interfaces for communication; and
a processing circuit configured to control the one or more interfaces and to carry out a method of claim 1 using the one or more interfaces.
